(19) United States
(12) Patent Application Publication
(10) Pub. No.: US 2017/0215400 A1
(43) Pub. Date: Aug. 3, 2017

(54) Fish Hook With Collet Chuck

(71) Applicant: Weldy R. Peguero, Fair Lawn, NJ (US)

(72) Inventor: Weldy R. Peguero, Fair Lawn, NJ (US)

(21) Appl. No.: 15/424,296

(22) Filed: Feb. 3, 2017

Related U.S. Application Data
(60) Provisional application No. 62/290,939, filed on Feb. 3, 2016.

(51) Int. Cl. A01K 91/04; F16B 7/04; A01K 83/00

(52) U.S. Cl. CPC A01K 91/04; A01K 83/00; F16B 7/0406

(57) ABSTRACT

The present invention is a fish hook and chuck combination. Said fish hook having a barbed tip on its distal end leading to a hooked portion. Said hooked portion leading to a substantially shank at a proximal end of said fish hook. Said proximal end removably clasped between at least two collets of a chuck, wherein said at least two collets being separated by evenly spaced longitudinal slits in said chuck. Wherein said proximal end is held between said at least two collets, wherein an axial force for retaining said proximal end within said at least two collets may be enhanced or reduced by varying a width of said slits using a reciprocally moving sleeve, said sleeve encircling an exterior of said at least two collets.

### CLAIM OF PRIORITY

This application claims priority of a Provisional Application for a Patent No. 62/290,939 filed on Feb. 3, 2016, the contents of which are fully incorporated herein by reference.

### FIELD OF THE INVENTION

The present invention relates to fishing hooks, in particular, to hooks that are be easily detachable from fishing lines and which are suitable for gentle spearing of bait.

### BACKGROUND OF THE INVENTION

In the art of fishing, hook and bait are arguably the most important elements. They represent the last barrier that separates the fisherman from his or her catch. More often than not, hook and bait determine whether an angler comes back with a catch or a blank.

The hooks that presently exist in the art, feature a hooked portion on one end, with a stem leading to a loop on the opposite end. The loop is tied to a fishing line to secure the fish hook on the line. This is the tried and true process of attaching fishing hooks to a line that has been used for the millennia.

One major weakness of the hooks that presently exist in the art is that the bait cannot be inserted from the stem of the hook toward the hooked portion. Instead, it must be impaled or skewered over the barb that is usually present on the hooked portion, then dragged through the hook to conceal the hook from approaching fish. Naturally, since the barb is very sharp, the dragging maneuver often leads to tearing and spoilage of the bait.

Similarly, once a fish has been snagged onto the hook, the hook cannot be detached without severing it from its fishing line. Instead, a hook must be carefully extracted through the mouth of the fish from within fish innards. Depending on the skill of the fisherman, the size of the catch and the location of the barb within the fish, this maneuver often leads to severing of the fish parts or innards, leading to possible spoilage of fish flesh or fish form, and where catch and release methods are required or preferred, conventional hooks may lead to mortal wounds and mutilation of fish organs.

Given fishhooks that presently exist in the art, an attachment of a fishhook to a line is a relatively permanent fitting. Therefore, notwithstanding the difficulty of removing these items without severing the hook from the fishing line, one would not detach a hook just to remove a catch or to re-attach bait. On the contrary, the use of the hook and chuck combination disclosed in the present invention is simple and convenient. Improving access to the bait or catch, or to enable angling using various hooks sizes and types. Using the present invention, and angler need not bring multiple fishing rods to target more than one species of fish. All that's required is to change the hook type on the same line, and one is back in business.

Various implements are known in the art, but fail to address all of the problems solved by the invention described herein. One embodiment of this invention is illustrated in the accompanying drawings and will be described in more detail herein below.

### SUMMARY OF THE INVENTION

The present invention is a fish hook and chuck combination. Said fish hook having a barbed tip on its distal end leading to a hooked portion. Said hooked portion leading to a substantially straight shank which terminates at a proximal end of said fish hook. Said proximal end removably clasped between at least two collets of a chuck, wherein said at least two collets being separated by evenly spaced longitudinal slits in said chuck. Wherein said proximal end is held between said at least two collets, wherein an axial force for retaining said proximal end within said at least two collets may be enhanced or reduced by varying a width of said slits using a reciprocally moving sleeve, said sleeve encircling an exterior of said at least two collets.

It is an object of the present invention to create an easily detachable angling hook.

It is still another object of the present invention to create a combination of an angling hook and a collet chuck to vastly improve angling experience.

It is yet another object of the present invention to enable for a quick clasp and release combination between a chuck and a hook, by implementing a collets that are stay closed, but which can be quickly released and closed through the help of a spring loaded sleeve.

It is still another object of the present invention to create a fishing hook where bait is introduced through the shank portion of the hook.

It is yet another objective of the present invention to create a fishing hook that may be varied without having to be removed from the actual fishing line.

It is still another objective of the present invention to create a fishing hook that is gentler on fish parts during extraction.

### BRIEF DESCRIPTION OF THE DRAWINGS

FIGS. 1a and 1b demonstrate one preferred embodiment and an alternative embodiment of the present invention.

FIGS. 2a, 2b, 2c, and 2d demonstrate the preferred embodiment of the present invention having a spring loaded sleeve.

FIGS. 3a, 3b, 3c, and 3d demonstrate an alternative embodiment of the present invention featuring a conical sleeve.

FIG. 4 is an exploded diagram of the present invention.

FIG. 5 is an exploded diagram of the present invention demonstrating the addition of a lure or bait over the shank portion of the hook.

FIG. 6 is a detailed cutaway portion of the inside of the chuck.

### DESCRIPTION OF THE PREFERRED EMBODIMENTS

The preferred embodiments of the present invention will now be described with reference to the drawings. Identical elements in the various figures are identified with the same reference numerals.

Reference will now be made in detail to embodiment of the present invention. Such embodiments are provided by way of explanation of the present invention, which is not intended to be limited thereto. In fact, those of ordinary skill in the art may appreciate upon reading the present specification and viewing the present drawings that various modifications and variations can be made thereto.

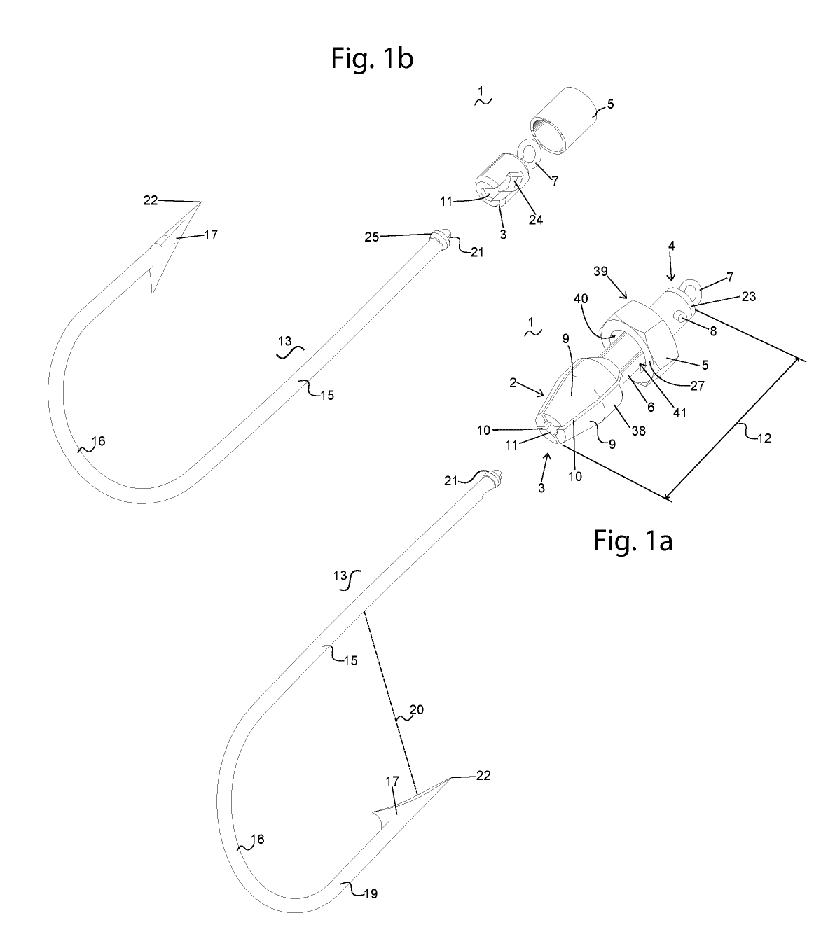

Turning now descriptively to the drawings, in which similar reference characters denote similar elements throughout the several views, the figures illustrate a collet chuck combination with a fish hook. FIG. 1a shows a collate chuck 1, a forward bulb 2, a front end 3, back end 4, sleeve 5, the cylindrical corpus 6, the loop 7, sleeve terminators 8, collates 9 and slits 10, the gap 11, the hook 13, the shank 15, the bend 16, the bite 19, the barb 17, the proximal end 21, the distal end 22, the end cap 23. The proximal end 21 is preferably spaded to facilitate entry into the gap 11 between individual collets 9. The gap 20 is preferably between ⅛ of an inch to 1.5 inches.

FIG. 1a describes collets 9, otherwise known as jaws, positioned radially around the gap 11, forming the structure of the forward bulb 2. The preferred embodiment of the present invention calls for at least two collets 9, but the actual number may be a factor of preference or size and diameter of the chuck 1.

The collets 9 are separated by gaps 10, which are slits longitudinally spanning the forward bulb 2 and the cylindrical corpus 6 from the front end 3 toward the back end 4. The chuck 1 is substantially cylindrical, having a thicker forward bulb 2 and the cylindrical corpus 6 of lesser diameter that extends to the back end 4.

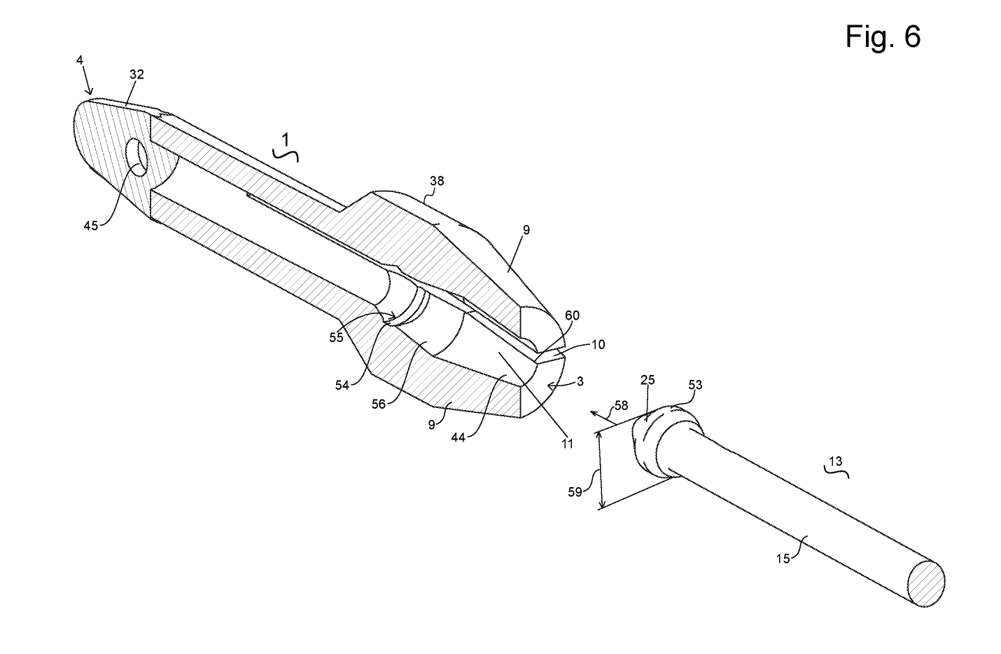

The chuck 1 may be hollow, or as shown in FIG. 6, or be composed entirely of individual collet strips 9 disposed in a circular fashion, with outer surfaces of these collets forming the cylindrical shaped corpus 6 representing the collet chuck 1. The purpose of the slits 10 is to provide elasticity to each collate 9 and to cause the individual collates 9 to be squeezed together radially about the gap 11, where the shank 15 or the proximal end 21 of the hook 13 is inserted and clasped by the axial force of the collates 9. The collets preferably all emanate from the same cylindrical corpus 6 and are only separated by the slits 10. Thus collates 9 are responsible for constricting and loosening the gap 11 to permit for easy insertion and removal of the proximate end 21. The spade 25 has a preferably wider diameter then the rest of the shank 15.

The sleeve 5 is a substantially cylindrical structure having a sidewall 39 that is preferably much shorter than the length of the corpus 6. The sidewall 39 may completely encircle the corpus 6 or may have a gap so as to be installed through this gap over the corpus 6. The sleeve 5 travels longitudinally but reciprocally (along the corpus 6 between the sleeve terminator protrusions 8 and the hump section 38 of the forward bulb 2. The diameter of the hump section 38, when collates 9 are not under any tension from the sleeve 5, is preferably slightly greater than the internal diameter 40 of the sleeve 6, but greater than the circumference of the narrow section of the chuck 1.

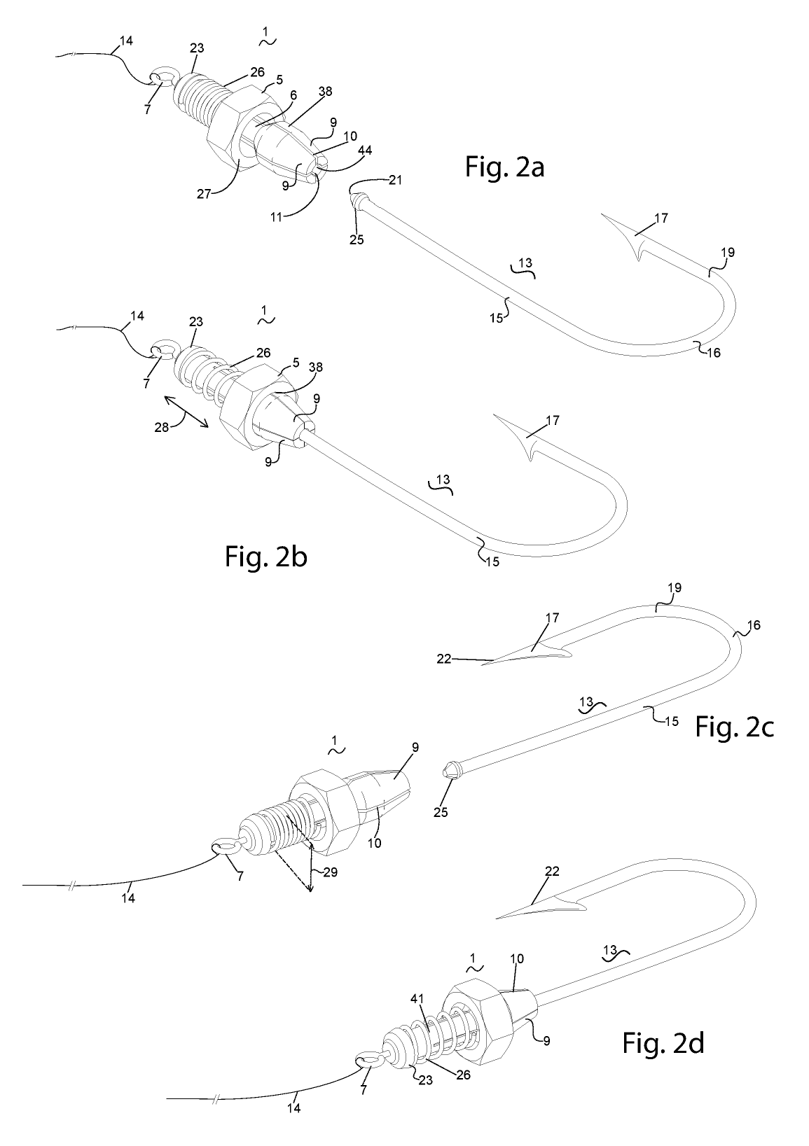

To operate the chuck 1 with the sleeve 5, one pushes the sleeve 5 in the direction 28 (FIG. 2b), forcing the forward edge 27 of the sleeve 5 to ride unto the forward bulb 2. At that point, a shank 15 residing within the gap 11 would be securely clasped. The sleeve 5 is retained in position while clasping the forward bulb 2 through frictional forces that are kept constant due to the biased tendency of the collets 9 to assume a straight shape. To release the shank 15 one pushes the sleeve back onto the narrow portion 41 of the corpus 6. The sleeve terminators 8 do not allow the sleeve to slip off of the shank. Alternatively, the functioned of sleeve terminators can be performed by the ring 7.

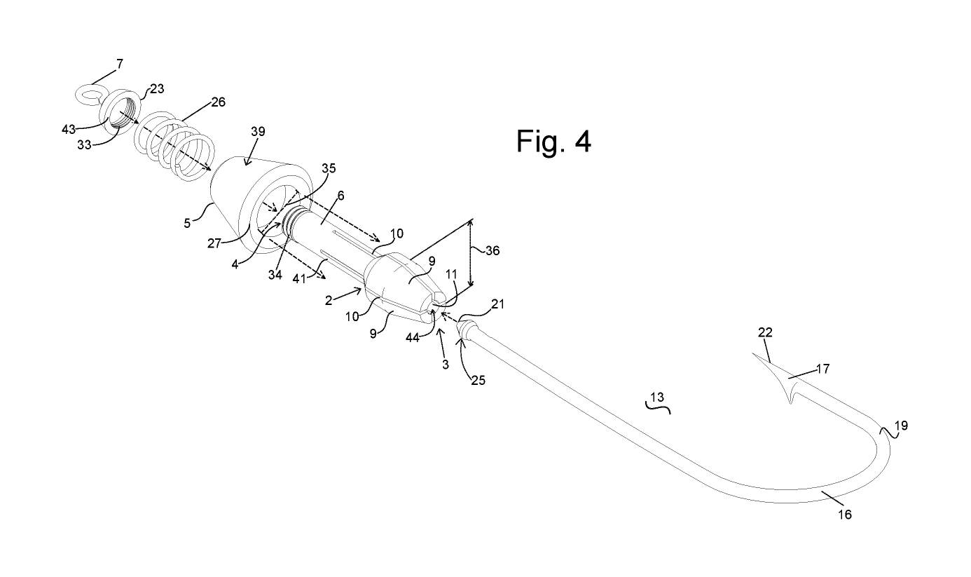

The chuck 1 and the sleeve 5 or any other component of this invention, may be manufactured from any metal alloy, steel, iron, wood or a polymeric substance, such as plastic. The preferable length 12 of the collet chuck 1 is in the range of a half to one and one half inches and between ⅛ and one half of an inch in diameter 36 (FIG. 4).

The sleeve 5, shown throughout the figs may be a ring, washer or a nut encircling the cylindrical corpus 6. The cylindrical characteristics of the corpus 6 and the sleeve 5 are a preferred embodiment, and may assume a more parallelogramic shapes in alternative embodiments; meaning that the cross section of corpus 6 or the sleeve 5 may also be square, or octagonal.

The forward bulb 2 is elliptical, with the circumference of the exterior wall of the bulb gradually widening until about midpoint of the bulb 2 and then narrowing again at the forward end 3. While the particular shape of the bulb is not controlling, the base of the bulb 57 that forms a conical flange with respect to the cylindrical corpus 6 is highly important, as it permits the sleeve to slide along the conical walls thereby forcing the collates 9 to squeeze together. The sleeve 5 may also have a threaded coupling with the cylinder corpus 6 or may snap into place when the desired clasping force of collates 9 is reached.

FIG. 1b is one of the alternative embodiments of the present invention. Shown is the book 13 and the shank 1. The shank 1 is unitary and has no collates 9. Instead of collates, the shank 1 contains a hollowed gap 24 that is connected with the gap 11 in one continuous channel. The gap 24 is hollowed into the side of the shank 24 and forms a keyhole for the spade 25. The spade 25, if turned sideways, such that the shank 15 will protrude through the gap 11, has a matching form that corresponds the form of the hollowed gap 24. Such that when the spade 25 is inserted sideways into the hollowed gap 24, it forms a lock and key combination. A sleeve 5 then slides over the shank 1 to keep the proximal end 21 from falling out of the hollowed gap 24. This design vastly simplifies the operation of the chuck 1 and ensures that the angler uses only the fish hooks that are prescribed for the chuck of this type.

FIGS. 2a-2d demonstrate, the chuck 1 with the sleeve 5 being regulated by a spring 26. The spring 26 when fully extended, places the sleeve 5 over the hump portion 38 of the forward bulb 2. Thus by default the collets 9 will constrict the gap 11 and thereby securely clasp the proximal end 21 of the shank 15 that may be residing inside. To release the proximal end 21 (or the spade point 25), a user would take hold of the sleeve 5, or the forward edge 27 of the sleeve 5, and press on the spring 26 to force it to compress. This action moves the sleeve off the the hump section 38, returning the collets 9 to their default straight orientation, thus releasing clasping tension exerted on the proximal end 21.

In FIGS. 2a-2d the ring 7 is the point of attachment of the chuck 1 to the fishing line 14. The ring 7 is shown mounted on the end cap 23, which offers a rim 43 (FIG. 4) for supporting the spring 26 as it is being compressed. The preferred length of the spring 26 is equal to the length of the narrow portion 41 of the corpus 6, but may be longer or shorter depending on the width of the sidewall 39 of the sleeve 5. The width 29 of the narrow section 41 is preferably ½ of the width or diameter 36 of the hump section 38.

Unlike prior art, the collate chuck 1 interposes between the hook 13 and the fishing line 14. Furthermore, more than one type of a fishhook 13 may be used. While a long fishhook 13 is shown throughout the figures, the fishhook 13 may actually be of any size, namely having a shorter or longer shank 15, a more oval or angular bend 16, or a variously shaped bite 19.

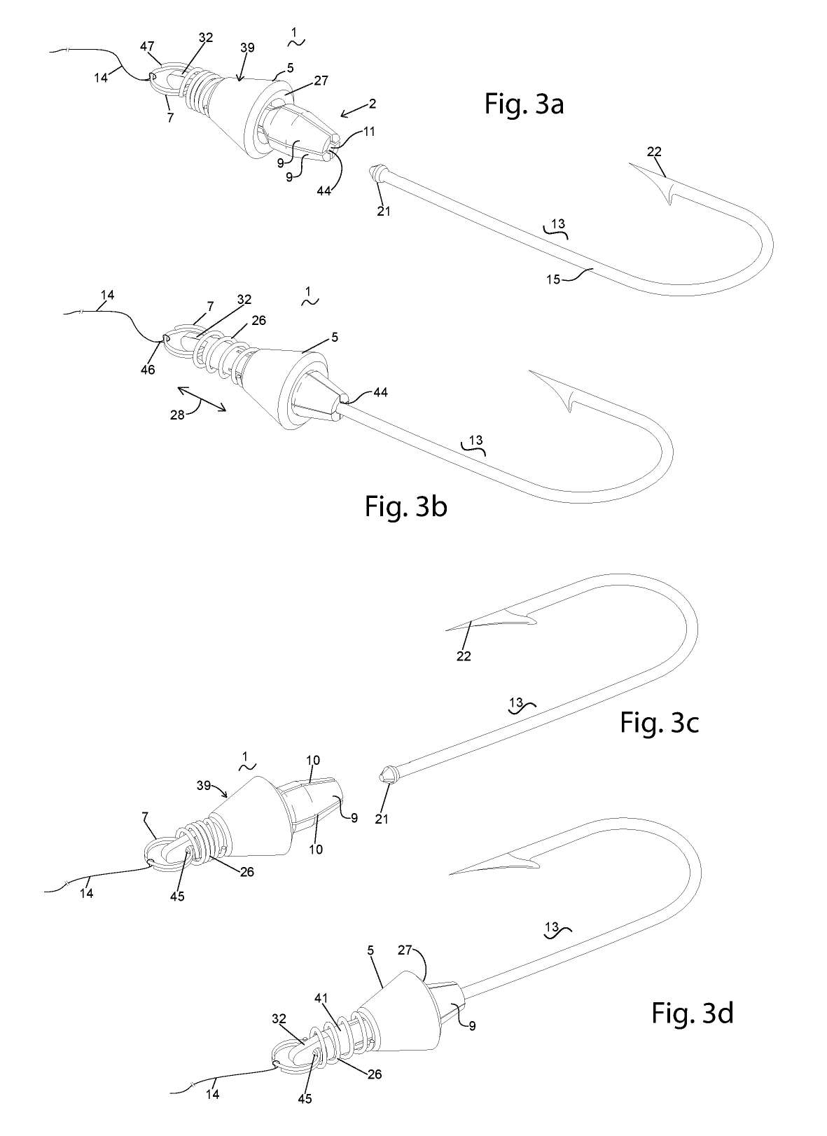

FIGS. 3a-3d demonstrate two alternative embodiments of the present invention. Still shown in the figures are the chuck 1, the fishhook 13, the collets 9, situated around the gap 11, the sleeve 5, the forward bulb 2, the spring 26, the ring 7 that connects the chuck 1 to the fish line 14. As in other figures the gap 11 is formed by having collets with flat or recessed bottom wall 44 rather than an angular one. The lack of angular bottom creates a gap of space, which when radially combined with other collets 9 forms a gap 11. In an embodiment having just two collets 9 a semicircular indentation would have to be present to accommodate the proximal end 21.

In FIGS. 3a and 3b the end cap 23 is replaced with an end section 32. The end section 32 may be stamped flat, or may retain the shape and width of the rest of the narrow section 41 of the corpus 6. The end section 32 contains an opening for the ring 7. The ring 7 in the embodiment shown is a key ring spiral that can be removed or reattached while still connecting to the fishing line 14. The fishing line 14 is tied in a knot around the key ring spirals, however, the key ring may preferably still rotate through the knot. While rotating, one may part an inner spiral of the ring 7 and insert the send section 32, turning the end section 32 through the spirals of the key ring 7 until the end section reaches the outside end 47 of the spirals. At that point, the chuck 1 would be detached from the ring 7 and fishing line 14 and may be replaced with a different chuck 1. Thus, the present invention supports interchangeable hooks 13 and interchangeable chucks 1.

Further in FIGS. 3a-3d, the ring 7 serves a dual purpose of retaining the fishing line 14 and as a support point for the spring 26. The spring 26 is forced against the ring 7 when being depressed and it prevents the spring 26 from slipping off the corpus 6 when the spring 26 is fully extended.

Still referring to FIGS. 3a-3d, the sleeve 5 has a conical sidewall 39 and a wider leading edge 27. Such a sleeve may be more appealing to users than one demonstrated in FIGS. 2a-2d as it presents a broader surface, with the angle of the conical sidewall 39 that would assist with forcing the sleeve 5 over the humped section 38. On the return trip, when depressing the sleeve 5 to release the proximal end 21, the leading edge 27 presents a convenient finger hold that is oriented optimally to provide optimal depressing force. The sleeve shown may exist whether or not the spring 26 is present. If the spring 26 is not present, the fishing line 14 may be tied to the chuck 1 directly through the opening 45.

FIG. 4 is an exploded diagram of one of the embodiments of the present invention. Shown are the ring 7, the end cap 23. The end cap 23 may be clamped, glued or threaded unto the end 4 of the chuck 1. The end 4 presents a corresponding threaded section 34, which may contain a tabbed or smooth surface to correspond to the method of attachment of the end cap 23. Also shown in FIG. 4 is the spring 26, the sleeve 5, having a conical sidewall 39 and a leading edge 27. The diameter 35 of the leading edge 27 is preferably slightly shorter than the diameter 36 of the forward bulb 2 to enable closure of the collets 9. The conical sidewall 39 continuously reducing the diameter 35 to prevent the sleeve 5 from slipping off of the front end 3. The chuck 1 is shown with four collets 9 that emanate from the back end 4 of the chuck 1 and are separated by slits 10. There is a gap 11 to permit insertion of the proximate end 21 of the hook 13.

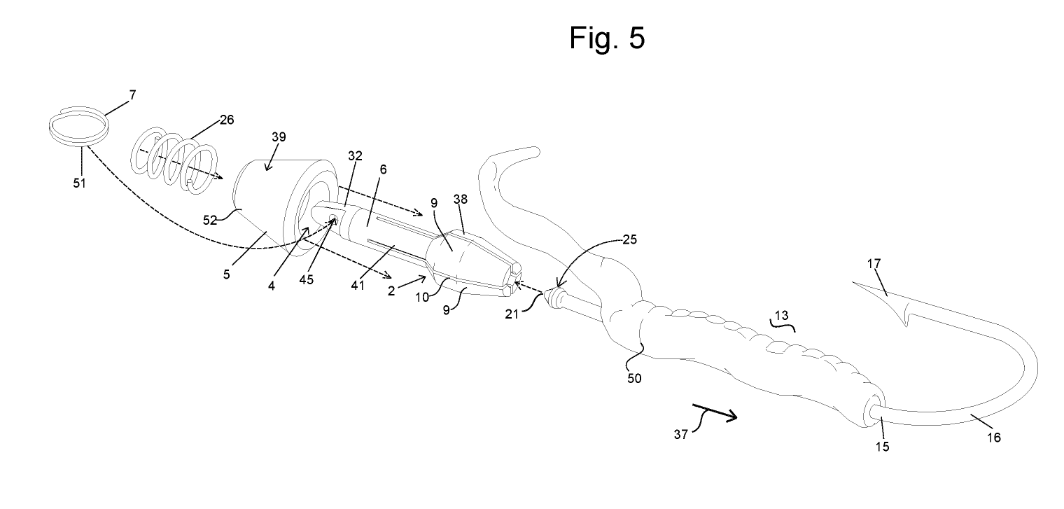

Demonstrated in FIG. 5 is how the fishhook 13 may be used to skewer bait. Shown is a drybait worm 50. The first end 15 of the fishhook 13 is inserted into the body of the drybait 50. The worm shown has been dragged or skewered over the straight stem of the fishhook 13 in the direction 37, until it completely covers the shank 15 and the bend 16. As one skilled in the art may appreciate, dragging the body of the bait over a substantially straight portion of the stem and not needing to deal with any hooks and barbs, is far more convenient and simpler than with art devices that presently exist in the art. Shank 15 and bend 16 do not contain any sharp points that may tear or mutilate the lure 50. Removal of the bait is performed in the opposite direction. However, the removal still takes place over the proximal end 21, while the hook 13 is decoupled from the chuck 1.

The drybait 50 is shown to be a worm, but it may be any other type or shape. It may be real or artificial lure. An additional benefit of ensuring that the bait is not torn is the ability to reuse bait. This is especially relevant for artificial bait that does not spoil.

FIG. 5 further demonstrates the ease with which the fishhook 13 can be removed from the collet chuck 1 for cleaning, baiting, or to insert a fishhook of different size and shape. For example, a larger fishhook may be used to catch large fish such as Tuna or Salmon, or when used while fishing from a boat in deeper waters. A fisherman may then attach smaller hooks to the same collet chuck 1 without having to bring additional fishing rods or spending time on equipment reconfiguration.

Also shown in FIG. 5 is the key ring 7 which preferably consists of spirals 51 that is inserted into the opening 45 of the end section 32. The ring 7 retains the spring 26 which is used to keep the sleeve 5 from sliding off of the humped section 38 toward the narrow section 41 of the corpus 6. The conical sidewall 39 is pointing toward the back end 4, resulting in a narrow back opening 52 that may serve to prevent the sleeve 5 from slipping over the bulb section 2 and off of the chuck 5.

FIG. 6 is a cutaway diagram of the chuck 6, demonstrating the internals and the coupling between the collets 9 and the spade 25 on the proximal end 21 of the fish hook 13. When the spade 25 is moved in the direction 58 towards the gap 11, it encounters the front end 3. At that point, the diameter 59 of the base of the spade 25 is somewhat wider than the entry diameter 11 formed by collets 9 that are radially situated next to each other, separated by slits 10. The conical shape of the spade 25 presents an angle to the forward end 3 that is conducive to moving apart or spreading the collets 9 from the gap 11, thus fording the spade 25 to enter the gap 11, which leads to the hollow channel 56. At the end of the channel 56 a hollowed gap 55 if formed as a cavity in a shape that corresponds to the shape of the spade 25. Once the spade band 53 enters the hollowed gap 55, it will correspond to the groove 54. At that point, the collets 9 will return to their default straight orientation, retaining the hook 13 inside the gap 11. Once a sleeve 5 rides over the forward hump 38, it further constricts the gap 11 around the shank 13. When the hook 13 is not clasped with the sleeve 5 inside the gap 11, it is able to axially rotate without falling out of the gap 11 since the extraction of the spade band from the grove 54 requires some linear force.

Although this invention has been described with a certain degree of particularity, it is to be understood that the present disclosure has been made only by way of illustration and that numerous changes in the details of construction and arrangement of parts may be resorted to without departing from the spirit and the scope of the invention.

What is claimed:

1. An angling apparatus comprising; a chuck, said chuck having a back end and a front end, said back end being uniform; a at least two collets radially issuing from said back end, said two collets radially separated from each other with slits, and each said collet having a bottom, wherein said at least two collets are comprised of a narrow section connecting to said back end and a wide section at said front end; wide sections of said at least two collets combining axially to form a bulb portion, wherein said collets are capable of flexing toward each other; and wherein said collets are biased to remain separate from each other; a gap, said gap formed by a combination of axially positioned collets, wherein said collets each having a recessed bottom; a sleeve, said sleeve having a sidewall, a front edge and a back edge forming a ring around said chuck, wherein an opening of said sleeve capable of longitudinal sliding over said forward bulb; wherein an internal diameter of an opening of said sleeve is equal to or less than the diameter of said forward bulb; and wherein said collets constricting said gap when said sleeve is slid over said forward bulb; and an opening on said back end, said opening used to attach said chuck to a line

2. The angling apparatus of claim 1, further comprising a ring, said ring attached to said back end, and said ring attaching said chuck to said line.

3. The angling apparatus of claim 1, further comprising a spring, said spring disposed between lip on said back end and said sleeve, wherein said spring is a compression spring biased to keeping said sleeve over said forward bulb, and wherein said lip preventing said spring from sliding off said chuck.

4. The angling apparatus of claim 1, further comprising a fish hook, said fish hook having a proximal end and a distal end, said proximal end forming a shank of said hook and said distal end having a barb of said hook, and wherein said proximal end of said hook removable inserted into said gap.

5. The angling apparatus of claim 4, wherein said proximal end forming a spade that is able to be inserted into a hollowed gap between said axially situated collets, wherein said spade and said hollowed gap enables a reduced clasping force on said hook which enables said hook to axially rotate while being retained within said gap

6. The angling apparatus of claim 4, wherein said proximal end further comprises a spade for easier insertion into said gap.

7. The angling apparatus of claim 2, further comprising a spring, said spring disposed between said ring and said sleeve, wherein said spring is a compression spring biased to keeping said sleeve over said forward bulb, and wherein said ring is preventing said spring from sliding off said chuck.

8. The angling apparatus of claim 4, wherein said hook is easily interchangeable.

9. The angling apparatus of claim 7, wherein said chuck may be detached from said ring while said ring is attached to said fish line.

10. The angling apparatus of claim 1, wherein said sleeve is in a shape comprising a conical shape or cylindrical shape or a ring shape or a combination of said shapes.

11. The angling apparatus of claim 1, wherein said sleeve is cylindrical.

12. An angling apparatus comprising: a chuck, said chuck having a back end and a front end; a sidewall of said chuck having a hollowed opening, said hollowed opening connecting to a gap in said front end through a channel, a sleeve, said sleeve longitudinally sliding over said hollowed opening; and a ring said ring connecting to a line.

13. The angling apparatus of claim 12, further comprising a fish hook, said fish hook having a proximal end and a distal end, said proximal end forming a shank of said hook and said distal end having a barb of said hook, and wherein said proximal end of said hook removably inserted into hollowed gap such that said shank protrudes from said gap.

14. The angling apparatus of claim 13, wherein said hollowed opening forms a keyhole, and wherein said proximal end contains a spade which fits said keyhole.

15. In combination a chuck and a hook comprising: a chuck, said chuck having a back end and a front end, said back end being uniform; a at least two collets radially issuing from said back end, said two collets radially separated from each other with slits, and each said collet having a bottom wherein said at least two collets are comprised of a narrow section connecting to said back end and a wide section at said front end; wide sections of said at least two collets when axially combined forming a bulb portion, wherein said collets are capable of flexing toward each other; and wherein said collets are biased to remain separate from each other; a gap, said gap formed by a combination of axially positioned collets wherein said collets each having a recessed bottom; a sleeve, said sleeve forming a ring around said chuck and having a sidewall, wherein an opening of said sleeve capable of longitudinal sliding over said forward bulb; wherein an internal diameter of an opening of said sleeve is equal to or less than the diameter of said forward bulb; and wherein said collets constricting said gap when said sleeve is slid over said forward bulb; an opening on said back end, said opening used to attach said chuck to a line; and a fish hook, said fish hook having a proximal end and a distal end, said proximal end forming a shank of said hook and said distal end having a barb of said hook, and wherein said proximal end of said hook removable inserted into said gap.

16. The combination of claim 15, further comprising a ring, said ring attached to said back end, and said ring attaching said chuck to said line.

17. The combination of claim 15, further comprising a spring, said spring disposed between lip on said back end and said sleeve, wherein said spring is a compression spring biased to keeping said sleeve over said forward bulb, and wherein said lip preventing said spring from sliding off said chuck.

18. The combination of claim 15, wherein said proximal end of said fish shook further comprises a spade, wherein said proximal end forming said spade that is able to be inserted into a hollowed gap between said axially situated collets, wherein said spade and said hollowed gap enables a reduced clasping force on said hook which enables said hook to axially rotate while being retained within said gap

19. The combination of claim 16, further comprising a spring, said spring disposed between said ring and said sleeve, wherein said spring is a compression spring biased to keeping said sleeve over said forward bulb, and wherein said ring is preventing said spring from sliding off said chuck.

20. The combination of claim 16, wherein said fish hook and said chuck may be interchangeable.
